(19) United States
(12) Patent Application Publication
(10) Pub. No.: US 2026/0366509 A1
(43) Pub. Date: Nov. 19, 2026

(54) ELECTRIC COMPRESSOR

(71) Applicant: SANDEN CORPORATION, Gunma (JP)

(72) Inventor: Toru SHIMADA, Gunma (JP)

(21) Appl. No.: 19/103,281

(22) PCT Filed: Jul. 27, 2023
(86) PCT No.: PCT/JP2023/027531

§ 371 Date: Feb. 12, 2025

(30) Foreign Application Priority Data
Aug. 24, 2022 (JP) 2022-133134

(51) Int. Cl. F04C 18/02; H02K 1/276; H02K 7/04

(52) U.S. Cl. CPC F04C 18/0215; H02K 1/276; H02K 7/04; F04C 2240/807

(57) ABSTRACT

The following abstract will replace all prior versions of the abstract in the application:

Provided is an electric compressor with a reduced dimension of an end plate for preventing movement of a permanent magnet built in a rotor core of a motor and a reduced material cost. The electric compressor includes a motor having a rotor in which a permanent magnet is built in a rotor core. The electric compressor includes end plates provided at end portions of the rotor core in an axial direction to limit movement of the permanent magnet in the axial direction, and balance weights provided at end portions of the rotor core in the axial direction. The end plates cover part of an end face of the rotor core in the axial direction, and the balance weights cover the remaining part of the end face to limit the movement of the permanent magnets in the axial direction.

### TECHNICAL FIELD

The present invention relates to an electric compressor including, in a housing, what is called a permanent magnet built-in type motor and a compression mechanism driven by the motor to compress working fluid.

### BACKGROUND ART

Conventionally, in the electric compressor of this type, the motor (electric motor) and the compression mechanism are provided in the housing (hermetic casing), and the compression mechanism is driven by the motor to compress the working fluid (refrigerant). In this case, the motor includes a stator and a rotor in which a permanent magnet rotating in the stator is built in a rotor core, and end plates (rotor end plates) are provided at both end portions of the rotor in an axial direction to prevent the permanent magnet from moving in the axial direction. The rotor is also provided with a balance weight for reducing vibration during rotation, and is attached to the face of the end plate opposite to the rotor core (see, for example, Patent Literature 1).

The structure of a rotor 100 of the conventional electric compressor above will be described with reference to FIGS. 3, 8, and 9, In FIG. 3, reference numeral 62 denotes a rotor core configured such that a plurality of electromagnetic steel sheets is laminated, and a through-hole 63 to which a rotary shaft (not illustrated) is attached is formed in the center of the rotor core 62. Further, four rivet holes 64 are formed so as to penetrate the periphery of the through-hole 63 in the axial direction, and a plurality of lightening holes 66 is formed between adjacent ones of the rivet holes 64. The lightening hole 66 is formed to such an extent that the lightening hole 66 penetrates or does not penetrate the rotor core 62 in the axial direction, and plays a role of reducing the weight of the rotor core 62 and keeping balance when the rotor core 62 rotates.

Eight slots 67 are formed so as to penetrate, in the axial direction, a peripheral portion of the rotor core 62 at positions outside the rivet hole 64 and the lightening hole 66, and permanent magnets 68 (a plurality of permanent magnets, eight in the embodiment) are each inserted into the slots 67 and built in the rotor core 62.

In FIG. 8, reference numeral 101 denotes a conventional end plate. The conventional end plate 101 has an annular shape, is provided at each end portion of the rotor core 62 in the axial direction, and covers the entirety of each end face of the rotor core 62 to limit movement of the permanent magnet 68 in the axial direction as illustrated in FIG. 9. Note that a rivet hole 103 and a lightening hole 104 are also formed so as to penetrate the end plate 101 at positions corresponding to the rivet hole 64 and the lightening hole 66 of the rotor core 62.

Further, reference numeral 102 denotes a balance weight. The balance weight 102 is provided to reduce vibration when the compression mechanism is driven, and two rivet holes (not illustrated) are also formed in the balance weight 102. Conventionally, as illustrated in FIG. 8, the balance weight 102 is laminated on the face of the end plate 101 at each end face on the side opposite to the rotor core 62, and fixed to the rotor core 62 together with the end plate 101 with rivets 105 inserted into the rivet holes 64, 104 (FIG. 8).

### CITATION LIST

### Patent Literature

Patent Literature 1: Japanese Patent No. 5858076

### SUMMARY OF INVENTION

### Problems to be Solved by Invention

As described above, in the conventional electric compressor, the end plate 101 covers the entirety of each end face of the rotor core 62, and the balance weight 102 is laminated on the end plate 101, which causes an increase in a material cost for the end plate 102.

The present invention has been made to solve these conventional technical problems, and is intended to provide an electric compressor with a reduced dimension of an end plate for preventing movement of a permanent magnet built in a rotor core of a motor and a reduced material cost.

### Solution to Problems

The electric compressor according to the present invention includes, in a housing, a motor having a rotor in which a permanent magnet is built in a rotor core and a compression mechanism driven by the motor to compress working fluid, which further includes an end plate provided at an end portion of the rotor core in an axial direction and configured to limit movement of the permanent magnet in the axial direction, and a balance weight provided at an end portion of the rotor core in the axial direction. The end plate covers part of an end face of the rotor core in the axial direction, and the balance weight covers the remaining part of the end face to limit the movement of the permanent magnet in the axial direction.

The electric compressor according to the invention of claim 2 is the electric compressor according to the above-mentioned invention, in which the compression mechanism is a scroll compression mechanism in which a movable scroll eccentrically revolves relative to a fixed scroll.

The electric compressor according to the invention of claim 3 is the electric compressor according to the invention of claim 1, in which the balance weight has a rivet hole, each of the end plate and the rotor core has a rivet hole and a lightening hole, the permanent magnet is built in the rotor core at a position outside the rivet hole and the lightening hole, and the end plate and the balance weight are fixed to the rotor core with a rivet inserted into the rivet hole.

The electric compressor according to the invention of claim 4 is the electric compressor according to the invention of claim 1, in which the end plate and the balance weight are provided at each end portion of the rotor core in the axial direction, and the circumferential dimensions of the end plate and the balance weight are different between one end portion and the other end portion of the rotor core.

The electric compressor according to the invention of claim 5 is the electric compressor according to each of the above-mentioned inventions, in which the motor is provided between a suction port for the working fluid, which formed in the housing, and the compression mechanism.

### Effects of Invention

According to the present invention, the electric compressor includes, in the housing, the motor having the rotor in which the permanent magnet is built in the rotor core and the compression mechanism driven by the motor to compress the working fluid, which further includes the end plate provided at the end portion of the rotor core in the axial direction and configured to limit the movement of the permanent magnet in the axial direction, and the balance weight provided at the end portion of the rotor core in the axial direction. The end plate covers part of the end face of the rotor core in the axial direction, and the balance weight covers the remaining part of the end face to limit the movement of the permanent magnet in the axial direction. Thus, the dimension of the end plate for preventing the movement of the permanent magnet built in the rotor core can be reduced, and the material cost can be reduced.

That is, in what is called a scroll electric compressor including the scroll compression mechanism in which the movable scroll eccentrically revolves as in the invention according to claim 2, the movement of the permanent magnet in the axial direction is directly limited by the balance weight which is essential for vibration reduction, so that the end plate is reduced in dimension, which is extremely effective for reducing the cost of the electric compressor as in the invention according to claim 2 or claim 5.

In this case, in a case where the balance weight has the rivet hole and each of the end plate and the rotor core has the rivet hole and the lightening hole as in the invention according to claim 3, the permanent magnet is built in the rotor core at the position outside these rivet hole and lightening hole, and the end plate and the balance weight are fixed to the rotor core with the rivet inserted into the rivet hole. Thus, the permanent magnet and the rivet and the lightening hole do not interfere with each other.

As in the invention according to claim 4, the end plate and the balance weight are provided at each end portion of the rotor core in the axial direction, and the circumferential dimensions of the end plate and the balance weight are different between the one end portion and the other end portion of the rotor core. Thus, the degree of freedom in adjustment of the balance of the rotor can be improved.

### BRIEF DESCRIPTION OF DRAWINGS

FIG. 1 is a longitudinal sectional side view of an electric compressor of an embodiment to which the present invention is applied.

FIG. 2 is a perspective view of a rotor forming a motor of the electric compressor of FIG. 1 (as viewed from a front bearing side).

FIG. 3 is a perspective view of a rotor core of the rotor of FIG. 2.

FIG. 4 is a perspective view of a state when an end plate and a balance weight are arranged on the rotor core of FIG. 3 (as viewed from the front bearing side).

FIG. 5 is a perspective view of a state when an end plate and a balance weight are arranged on the rotor core of FIG. 3 (as viewed from a rear bearing side).

FIG. 6 is a view of a state when the rotor core, the end plate, and the balance weight of FIG. 4 are fixed with rivets.

FIG. 7 is a view of a state when the rotor core, the end plate, and the balance weight of FIG. 5 are fixed with rivets.

FIG. 8 is a perspective view of a rotor forming a motor of a conventional electric compressor.

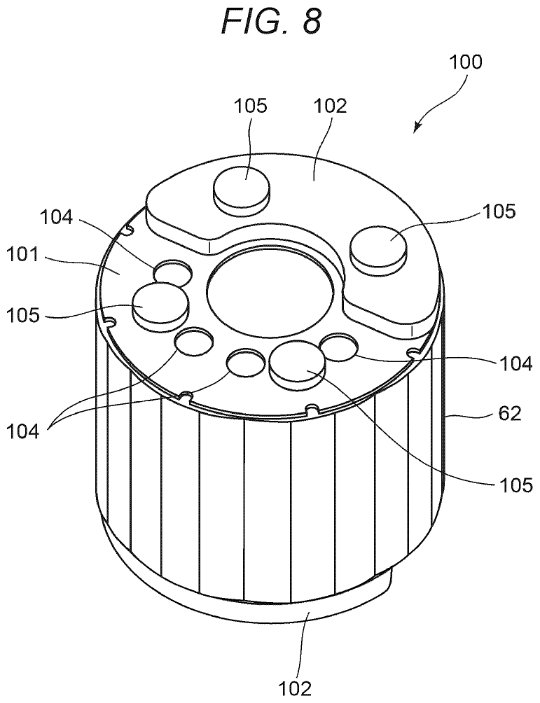

FIG. 9 is a perspective view of a rotor core of the rotor of FIG. 8 and an end plate.

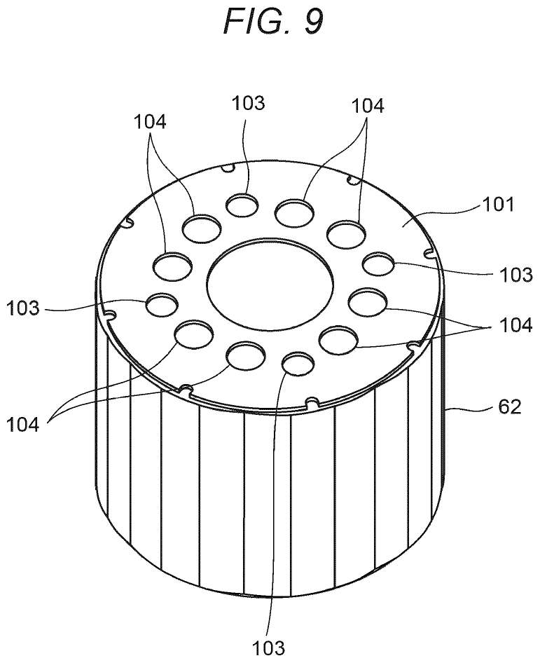

### DESCRIPTION OF EMBODIMENTS

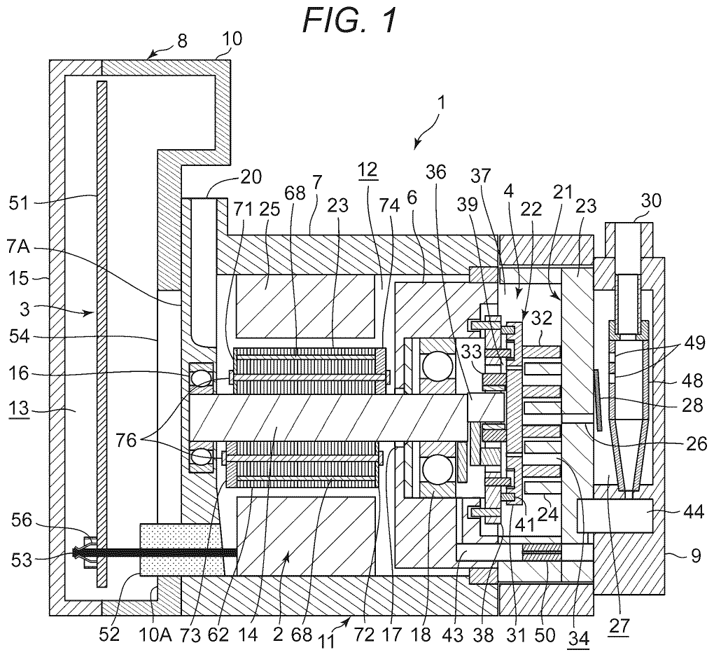

Hereinafter, embodiments of the present invention will be described in detail with reference to the drawings. FIG. 1 is a longitudinal sectional side view of an electric compressor 1 of an embodiment to which the present invention is applied.

The electric compressor 1 of the embodiment is used, for example, in a refrigerant circuit of an air-conditioning device for an electric vehicle, and sucks and compresses refrigerant as working fluid for the air-conditioning device, and discharges the refrigerant into a discharge pipe. The electric compressor 1 is what is called a horizontal inverter-integrated scroll electric compressor including a three-phase motor 2 as an example of a motor in the present invention, an inverter 3 for operating the motor 2, and a scroll compression mechanism 4 as an example of a compression mechanism driven by the motor 2.

The electric compressor 1 of the embodiment includes a stator housing 7 accommodating the motor 2 and a center casing 6 therein, an inverter case 8 attached to a one-end-side end wall 7A of the stator housing 7 and accommodating the inverter 3 therein, and a rear casing 9 attached to the other end side of the stator housing 7.

The stator housing 7, the inverter case 8, and the rear casing 9 are all made of metal (aluminum in the embodiment), and are integrally joined together to form a housing 11 of the electric compressor 1 of the embodiment.

A motor chamber 12 accommodating the motor 2 is formed in the stator housing 7, and one end face of the motor chamber 12 is basically closed with the end wall 7A of the stator housing 7. The end wall 7A serves as a partition wall defining the motor chamber 12 and an inverter accommodation portion 13 to be described later. The other end face of the motor chamber 12 is opened, and the center casing 6 is accommodated in the opening after the motor 2 has been accommodated. Moreover, a front bearing 16 for rotatably supporting one end portion of a rotary shaft 14 of the motor 2 is attached to the inner face (motor chamber 12 side) of the end wall 7A.

The center casing 6 is opened on a side opposite to the motor 2 (other end side). After a movable scroll 22, which is described below, of the scroll compression mechanism 4 has been accommodated in this opening, the rear casing 9 to which a fixed scroll 21, which is also described below, of the scroll compression mechanism 4 is fixed is fixed to the stator housing 7 to close the opening.

Moreover, a through-hole 17 through which the other end portion of the rotary shaft 14 of the motor 2 is inserted is opened in the center casing 6, and a rear bearing 18 rotatably supporting the other end portion of the rotary shaft 14 on the scroll compression mechanism 4 side is attached on the scroll compression mechanism 4 side in the through-hole 17 in the center casing 6.

The motor 2 includes a stator 25 around which a coil is wound and which is fixed to the inside of a peripheral wall of the stator housing 7, and a rotor 23 which rotates inside the stator 25. The rotor 23 will be described in detail later. In addition, it is configured in such a manner that, for example, direct current from a battery (not illustrated) of the vehicle is converted into three-phase alternating current by the inverter 3 to be supplied to the coil of the stator 25 of the motor 2 and the rotor 23 is rotationally driven accordingly. In addition, the rotary shaft 14 is fixed to the rotor 23.

Moreover, a suction port 20 is formed in the stator housing 7, and refrigerant sucked through the suction port 20 passes through the motor 2 in the stator housing 7, then flows into the center casing 6, and is sucked into a suction portion 37 outside the scroll compression mechanism 4. That is, since the motor 2 is provided between the suction port 20 and the scroll compression mechanism 4, the motor 2 is cooled with the sucked refrigerant. Moreover, it is configured in such a manner that refrigerant compressed by the scroll compression mechanism 4 is discharged from a discharge chamber 27 to be described later into the discharge pipe of the refrigerant circuit (not illustrated) outside the housing 11 through a discharge port 30 formed in the rear casing 9.

The scroll compression mechanism 4 includes the above-mentioned fixed scroll 21 and movable scroll 22. The fixed scroll 21 integrally includes a disk-shaped end plate 23 and a wrap 24 erected on a face (one face) of the end plate 23, the wrap 24 having an involute shape or a spiral shape formed of a curve closer to the involute shape, and is fixed to the rear casing 9 with the face, on which the wrap 24 is erected, of the end plate 23 facing the center casing 6. A discharge hole 26 is formed in the center of the end plate 23 of the fixed scroll 21, and the discharge hole 26 communicates with the discharge chamber 27 in the rear casing 9. In the drawing, reference numeral 28 denotes a discharge valve provided in an opening of the discharge hole 26 on the back (other face) side of the end plate 23.

The movable scroll 22 is a scroll which eccentrically revolves (orbits) relative to the fixed scroll 21, and integrally includes a disk-shaped end plate 31, a wrap 32 erected on a face (one face) of the end plate 31, the wrap 32 having an involute shape or a spiral shape formed of a curve closer to the involute shape, and a boss 33 protruding from the center of the back face (other face) of the end plate 31. The movable scroll 22 is disposed in such a manner that the wrap 32 faces and meshes with the wrap 24 of the fixed scroll 21 with the protruding direction of the wrap 32 facing the fixed scroll 21, and a pressure chamber 34 is formed between the wraps 24, 32.

That is, the wrap 32 of the movable scroll 22 faces the wrap 24 of the fixed scroll 21, and meshes with the wrap 24 in such a manner that the distal end of the wrap 32 is in contact with the face of the end plate 23 and the distal end of the wrap 24 is in contact with the face of the end plate 31, and an eccentric portion 36 provided at the other end of the rotary shaft 14 so as to be eccentric to the axis is fitted in the boss 33 of the movable scroll 22. When the rotary shaft 14 is rotated together with the rotor 23 of the motor 2, the movable scroll 22 eccentrically revolves (orbits) relative to the fixed scroll 21 without rotating.

Since the movable scroll 22 eccentrically orbits relative to the fixed scroll 21, the eccentric direction and contact position of each wrap 24, 32 move during rotation, and the pressure chamber 34 having sucked refrigerant from the above-mentioned suction portion 37 on the outside is gradually narrowed while moving inward. As a result, the refrigerant is compressed and finally discharged from the center discharge hole 26 to the discharge chamber 27 through the discharge valve 28.

In FIG. 1, reference numeral 38 denotes an annular thrust plate. The thrust plate 38 sections a back pressure chamber 39 formed between the back face of the end plate 31 of the movable scroll 22 and the center casing 6 and the suction portion 37 outside the scroll compression mechanism 4, and is located outside the boss 33 and interposed between the center casing 6 and the movable scroll 22. Moreover, reference numeral 41 denotes a sealing member attached to the back face of the end plate 31 of the movable scroll 22 and contacting the thrust plate 38. The sealing member 41 and the thrust plate 38 section the back pressure chamber 39 and the suction portion 37.

Moreover, reference numeral 48 denotes a centrifugal oil separator attached in the discharge chamber 27 of the rear casing 9 (housing 11). The oil separator 48 separates lubricating oil mixed in refrigerant discharged from the scroll compression mechanism 4 into the discharge chamber 27, from the refrigerant. The oil separator 48 is formed with an inflow port 49, and the refrigerant containing the oil, which has flowed in through the inflow port 49, swirls in the oil separator 48. The oil is separated by the centrifugal force at this time, and the refrigerant flows from an outflow port at the upper end toward the discharge port 30, and is discharged to the discharge pipe described above.

The rear casing 9 is formed with an oil reservoir 44 below the oil separator 48, and the oil separated from the refrigerant by the oil separator 48 flows into the oil reservoir 44 from the lower end of the oil separator 48. In the drawing, reference numeral 43 denotes a back pressure passage formed from the rear casing 9 to the center casing 6. The back pressure passage 43 is a path causing the oil separator 48 in the discharge chamber 27 (on the discharge side of the scroll compression mechanism 4) in the rear casing 9 to communicate with the back pressure chamber 39, and has an orifice 50 in the embodiment. As a result, it is configured in such a manner that discharge pressure adjusted and reduced by the orifice 50 of the back pressure passage 43 is supplied to the back pressure chamber 39 together with the oil in the oil reservoir 44, which is separated by the oil separator 48.

The pressure (back pressure) in the back pressure chamber 39 generates a back pressure load which presses the movable scroll 22 against the fixed scroll 21. Under the back pressure load, the movable scroll 22 is pressed against the fixed scroll 21 against compression reaction force from the pressure chamber 34 of the scroll compression mechanism 4, the contact between the wraps 24, 32 and the end plates 31, 23 is maintained, and refrigerant can be compressed in the pressure chamber 34.

On the other hand, the inverter case 8 includes a case body 10 forming the inverter accommodation portion 13 in which the inverter 3 is accommodated, and a lid member 15 closing an opening in one end face of the case body 10. The lid member 15 is attached to the case body 10 after the inverter 3 has been accommodated in the inverter accommodation portion 13. The inverter 3 of the embodiment is configured such that a control circuit is mounted on one circuit board 51 and a switching element, a smoothing capacitor, and the like (not illustrated) are connected thereto.

Here, a hermetic plate 52 is attached to the end wall 7A (partition wall) of the stator housing 7, and a conductive hermetic pin 53 is attached to the hermetic plate 52. In this case, three hermetic pins 53 are attached corresponding to the phases (three phases) of the motor 2, and one end side of each hermetic pin 53 penetrates the end wall 7A into the motor chamber 12 and is connected to the coil of the stator 25 of the motor 2.

In addition, three metal press-fit terminals 56 called power baskets are attached to the circuit board 51 at the position corresponding to the other end side of each hermetic pin 53, and the other end side of each hermetic pin 53 enters a corresponding one of the press-fit terminals 56 and is pressure-welded (press-fitted) to such a press-fit terminal 56. Thus, each hermetic pin 53 is electrically connected to the circuit board 51.

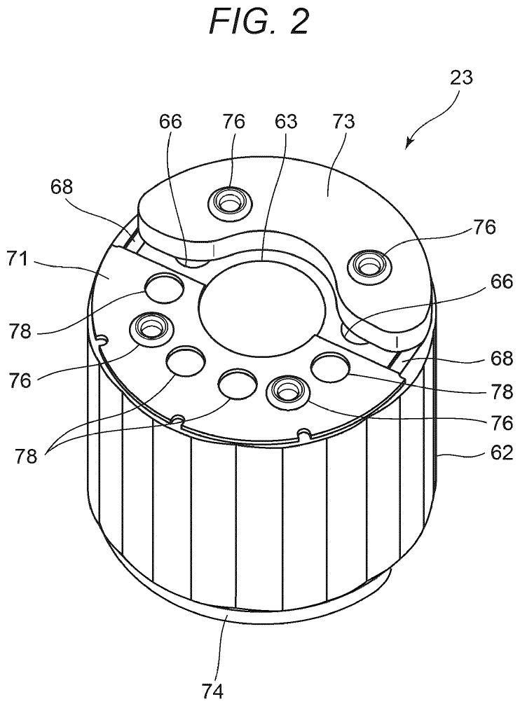

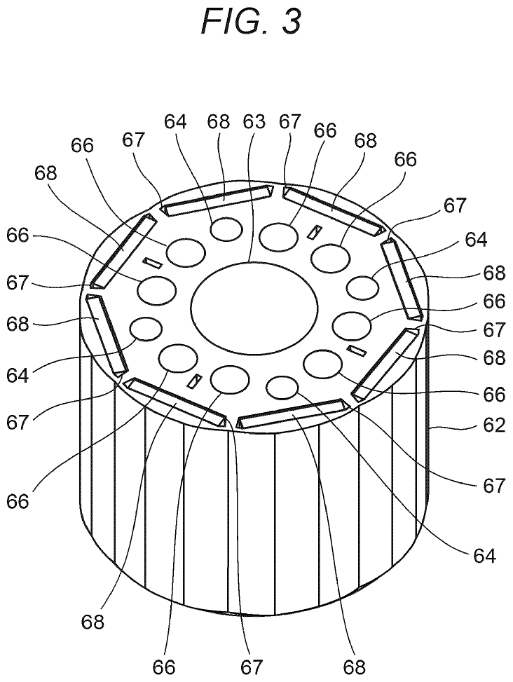

Next, the configuration of the above-mentioned rotor 23 of the motor 2 will be described in detail with reference to FIGS. 2 to 7. The rotor 23 of the embodiment also has a configuration in which a rotor core 62, end plates 71, 72, and balance weights 73, 74 are integrated with a rivet 76. Here, the rotor core 62 is similar to that in FIG. 3 as described above. That is, the rotor core 62 is configured such that a plurality of electromagnetic steel sheets is laminated, and a through-hole 63 to which the rotary shaft 14 is attached is formed in the center of the rotor core 62.

Further, four rivet holes 64 are formed so as to penetrate the periphery of the through-hole 63 in the axial direction, and a plurality of lightening holes 66 is formed between adjacent ones of the rivet holes 64. The lightening hole 66 is formed to such an extent that the lightening hole 66 penetrates or does not penetrate the rotor core 62 in the axial direction, and plays a role of reducing the weight of the rotor core 62 and keeping balance when the rotor core 62 rotates.

Eight slots 67 are formed so as to penetrate, in the axial direction, a peripheral portion of the rotor core 62 at positions outside the rivet hole 64 and the lightening hole 66, and permanent magnets 68 (a plurality of permanent magnets, eight in the embodiment) are each inserted into the slots 67 and built in the rotor core 62.

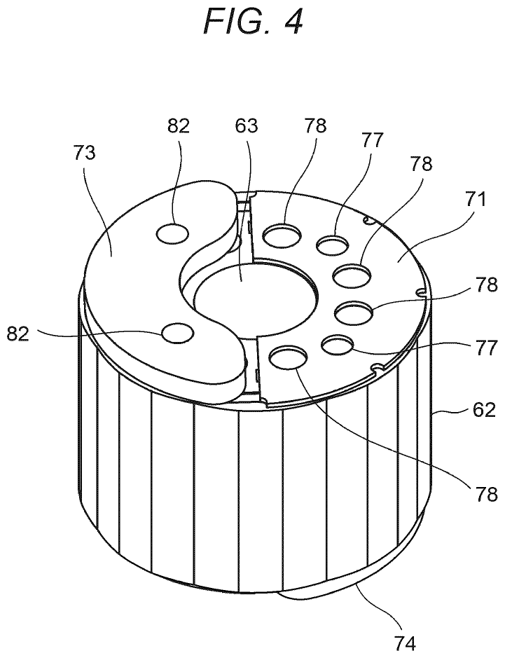

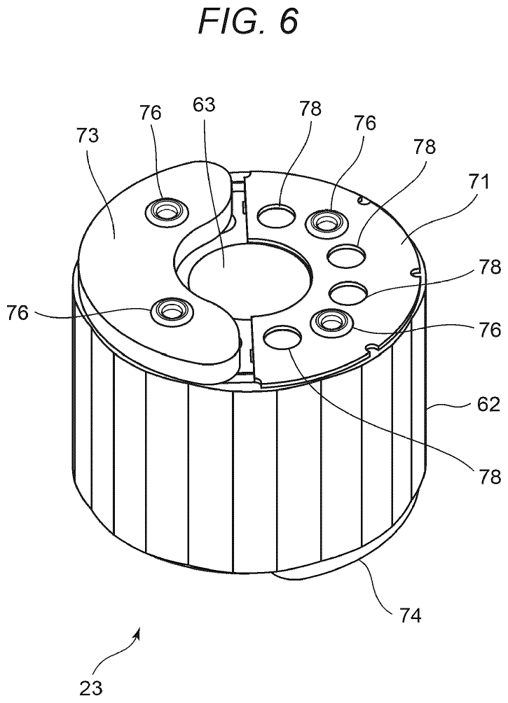

In FIGS. 1, 2, and 4 to 7, the end plates 71, 72 of the embodiment have a substantially semicircular arc shape (substantially half shape of an annular shape), and the end plate 71 is provided at one end portion (end portion on the front bearing 16 side) of the rotor core 62 in the axial direction. As illustrated in FIGS. 4 and 6, the end plate 71 covers substantially the half (part of the end face) of one end face of the rotor core 62 to limit movement of the permanent magnet 68 in the axial direction. A rivet hole 77 and a lightening hole 78 are also formed so as to penetrate the end plate 71 at positions corresponding to the rivet hole 64 and the lightening hole 66 of the rotor core 62.

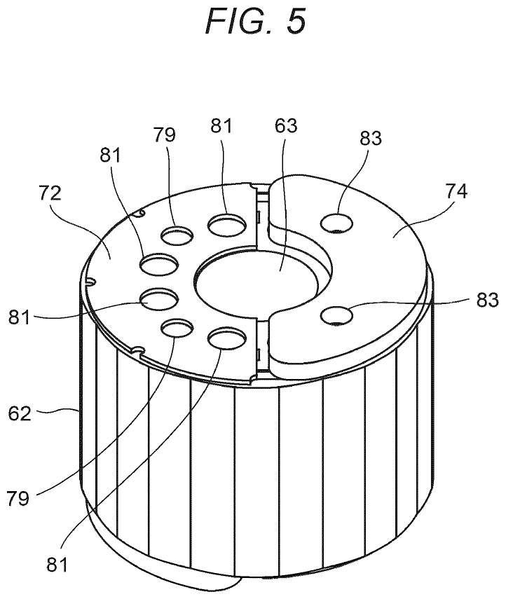

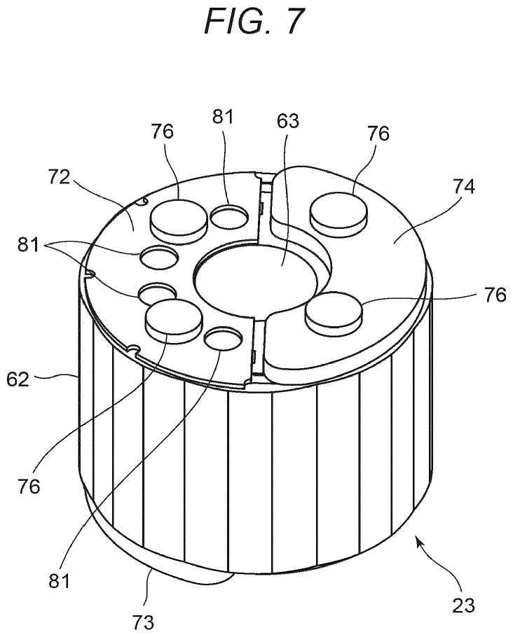

The end plate 72 is provided at the other end portion (end portion on the rear bearing 18 side) of the rotor core 62 in the axial direction. As illustrated in FIGS. 5 and 7, the end plate 72 covers substantially the half (part of the end face) of the other end face of the rotor core 62 to limit the movement of the permanent magnet 68 in the axial direction. Note that the end plate 72 is provided at a position opposite to the end plate 71 with the through-hole 63 interposed therebetween. A rivet hole 79 and a lightening hole 81 are also formed so as to penetrate the end plate 72 at positions corresponding to the rivet hole 64 and the lightening hole 66 of the rotor core 62.

Furthermore, the balance weights 73, 74 of the embodiment are also provided to reduce vibration when the scroll compression mechanism 4 is driven, and the balance weight 73 has a substantially semicircular arc shape (substantially half shape of an annular shape). The balance weight 73 is provided at the one end portion (end portion on the front bearing 16 side) of the rotor core 62 in the axial direction. In the present invention, as illustrated in FIGS. 4 and 6, the balance weight 73 covers substantially the half (remaining part of the end face) of the one end face of the rotor core 62, which is not covered with the end plate 71, to limit the movement of the permanent magnet 68 in the axial direction. A rivet hole 82 is also formed so as to penetrate the balance weight 73 at a position corresponding to the rivet hole 64 of the rotor core 62.

The balance weight 74 also has a substantially semicircular arc shape (substantially half shape of an annular shape). The balance weight 74 is provided at the other end portion (end portion on the rear bearing 18 side) of the rotor core 62 in the axial direction. In the present invention, as illustrated in FIGS. 5 and 7, the balance weight 74 covers substantially the half (remaining part of the end face) of the other end face of the rotor core 62, which is not covered with the end plate 72, to limit the movement of the permanent magnet 68 in the axial direction. Note that the balance weight 74 is also provided at a position opposite to the balance weight 73 with the through-hole 63 interposed therebetween. A rivet hole 83 is also formed so as to penetrate the balance weight 74 at a position corresponding to the rivet hole 64 of the rotor core 62.

The end plates 71, 72 and the balance weights 73, 74 are fixed to the rotor core 62 with the rivets 76 inserted into the rivet holes 64, 77, 79, 82, 83 (FIGS. 1, 2, 6, and 7).

As described above, in the present invention, each of the end plates 71, 72 covers part (substantially half in the embodiment) of the end face of the rotor core 62 in the axial direction, and each of the balance weights 73, 74 covers the remaining part of the end face to limit the movement of the permanent magnet 68 in the axial direction.

Therefore, the dimensions of the end plates 71, 72 for preventing the movement of the permanent magnet 68 built in the rotor core 62 can be reduced (reduced to substantially half in the embodiment) as compared with the related art, and the material cost of the end plates 71, 72 can also be reduced.

That is, in the electric compressor 1 including the scroll compression mechanism 4 in which the movable scroll 22 eccentrically revolves as in the embodiment, the movement of the permanent magnet 68 in the axial direction is directly limited by the balance weights 73, 74, which are essential for vibration reduction, so that the end plates 71, 72 are reduced in dimension, which is extremely effective for reducing the cost of the electric compressor 1.

In this case, in the embodiment, the balance weights 73, 74 have the rivet holes 82, 83, the end plates 71, 72 and the rotor core 62 have the rivet holes 77, 79, 64 and the lightening holes 78, 81, 66, respectively, the permanent magnet 68 is built in the rotor core 62 at the position outside these rivet holes and lightening holes, and the end plates 71, 72 and the balance weights 73, 74 are fixed to the rotor core 62 with the rivets 76 inserted into the rivet holes 82, 83, 77, 79, 64. Thus, the permanent magnet 68 and the rivets 82, 83, 77, 79, 64 and the lightening holes 78, 81, 66 do not interfere with each other.

Note that the circumferential dimensions of the end plate 71 and the balance weight 73 provided at the one end portion of the rotor core 62 and the circumferential dimensions of the end plate 72 and the balance weight 74 provided at the other end portion may be the same as each other or different from each other. Also in the above-mentioned embodiment, as can be seen from comparison between FIGS. 4 and 5, the circumferential dimension of the balance weight 74 is made slightly larger than that of the balance weight 73. As a result, the degree of freedom in adjustment of the balance of the rotor 23 can be improved.

The specific shapes of the end plates 71, 72 and the balance weights 73, 74 described in the embodiments are not limited to above, and it goes without saying that these shapes can be changed without departing from the gist of the present invention.

### LIST OF REFERENCE SIGNS

1 Electric Compressor
2 Motor
4 Scroll Compression Mechanism (Compression Mechanism)
7 Stator Housing
11 Housing
12 Motor Chamber
20 Suction Port
23 Rotor
62 Rotor Core
68 Permanent Magnet
64, 77, 79, 82, 83 Rivet Hole
66, 78, 81 Lightening Hole
71, 72 End Plate
73, 74 Balance Weight
76 Rivet

1. An electric compressor including, in a housing, a motor having a rotor in which a permanent magnet is built in a rotor core and a compression mechanism driven by the motor to compress working fluid, the electric compressor comprising:
an end plate provided at an end portion of the rotor core in an axial direction and configured to limit movement of the permanent magnet in the axial direction; and
a balance weight provided at an end portion of the rotor core in the axial direction,
wherein the end plate covers part of an end face of the rotor core in the axial direction, and
the balance weight covers remaining part of the end face to limit the movement of the permanent magnet in the axial direction.

2. The electric compressor according to claim 1, wherein the compression mechanism is a scroll compression mechanism in which a movable scroll eccentrically revolves relative to a fixed scroll.

3. The electric compressor according to claim 1, wherein
the balance weight has a rivet hole,
each of the end plate and the rotor core has a rivet hole and a lightening hole,
the permanent magnet is built in the rotor core at a position outside the rivet hole and the lightening hole, and
the end plate and the balance weight are fixed to the rotor core with a rivet inserted into the rivet hole.

4. The electric compressor according to claim 1, wherein
the end plate and the balance weight are provided at each end portion of the rotor core in the axial direction, and
circumferential dimensions of the end plate and the balance weight are different between one end portion and the other end portion of the rotor core.

5. The electric compressor according to claim 1, wherein the motor is provided between a suction port for the working fluid, which formed in the housing, and the compression mechanism.
